(19) United States
(12) Patent Application Publication
(10) Pub. No.: US 2006/0160893 A1
(43) Pub. Date: Jul. 20, 2006

(54) Method for enhancing the quality of berry fruit

(76) Inventors: Albert Bassi, Greensboro, NC (US); Martin D. Wiglesworth, Roseville, CA (US)

Correspondence Address: SYNGENTA CROP PROTECTION , INC.;PATENT AND TRADEMARK DEPARTMENT, 410 SWING ROAD, GREENSBORO, NC, 27409, US

(21) Appl. No.: 11/370,112

(22) Filed: Mar. 7, 2006

Related U.S. Application Data
(63) Continuation of application No. 10/468,682, filed on Feb. 2, 2004.
(60) Provisional application No. 60/270,372, filed on Feb. 21, 2001.

(51) Int. Cl. A01N 37/34

(52) U.S. Cl. 514/521

(57) ABSTRACT

A method of producing berry fruits having an enhanced quality, extended shelf life and/or a reduced level of fungal contamination is provided, comprising: (a) providing a first fungicidal composition comprising a mixture of cyprodinil (I) and fludioxonil (II), and a fungicidally acceptable carrier (such as in a suitable volume of water in a spray tank to form a spray composition),
(b) applying said fungicidal composition at a time T₀ (such as by means of a sprayer fed from the spray tank) to a soil surface in the field, to foliage and/or to flowers of berry fruit crops that have emerged above the soil surface,
(c) optionally providing a second fungicidal composition comprising an alternate fungicide different form said first fungicide, and a fungicidally acceptable carrier (such as in a suitable volume of water in a spray tank to form a spray composition) and applying the second composition at a time T₀ plus or minus (+/−) 5 to 20 days to a soil surface in the field, to foliage and/or to flowers of berry fruit crops that have emerged above the soil surface; and
(d) harvesting said berry fruit crop from about 0 to about 60 days after T₀; preferably from about 5 to about 45 days after T₀.

### FIELD OF THE INVENTION

The present invention relates to methods and compositions for producing berry fruits having an enhanced quality and extended shelf life.

### BACKGROUND OF THE INVENTION

Spoilage of berry fruits prior to consumer purchase or consumption remains a major problem in the agricultural industry. Simply put, consumers will not purchase or consume berry fruits that show signs of spoilage. Accordingly, spoilage is both a major source of lost revenue for the agricultural and grocery industries and a major source of frustration for the consumer.

Refrigeration helps to preserve the organolectic qualities, e.g., taste and texture for a limited number of hours. Preservation methods such as heating, drying and dehydration can radically alter the texture, flavor and appearance of a berry fruit. Post-harvest applied chemical preservatives typically leave a residual taste and/or do not maintain the characteristic appearance, texture, flavor or moisture of the berry fruit. Certain chemical preservatives such as sulfites have come under scrutiny as having negative health risks.

It would be desirable to have a method for increasing the shelf life of freshly harvested berry fruits that preserves their appearance, texture, flavor and moisture without requiring heating, drying, dehydration, freezing or post-harvest applied chemical preservatives.

### SUMMARY OF THE INVENTION

The present invention is based on the discovery that the quality of berry fruits can be improved and the shelf life of berry fruits can be extended by the pre-harvest treatment of a berry fruit crop with at least one fungicidal composition containing a mixture of at least one phenylpyrrole and at least one anilinopyrimidine. The pre-harvest treatment surprisingly suppresses fungal contamination of the harvested berry fruit crop and increases shelf life, without adversely affecting the organoleptic properties of the berry fruit (which means enhanced quality).

In particular, it has been found that the pre-harvest program comprising application of (A) a mixture comprising cyprodinil (I) and fludioxonil (II), in any desired order or simultaneously, and, optionally, (B) at least one alternate fungicide either before or after the application of (A), to the berry fruit plants, or to the locus thereof results in a quite unexpectedly enhanced quality, safety and shelf life for the harvested berry fruit crop.

The invention also relates to a berry fruit produced from a crop treated using a mixture according to the invention. It also relates to packages and shipping containers comprising the berry fruit produced in accordance with the method of the invention.

### DETAILED DESCRIPTION

Accordingly, in one embodiment the present invention may be accomplished with a method of producing berry fruits having an enhanced quality, extended shelf life and/or a reduced level of fungal contamination, comprising:
(a) providing a first fungicidal composition comprising a mixture of cyprodinil (I) and fludioxonil (II), and a fungicidally acceptable carrier (such as in a suitable volume of water in a spray tank to form a spray composition),
(b) applying said fungicidal composition at a time T₀ (such as by means of a sprayer fed from the spray tank) to a soil surface in the field, to foliage and/or to flowers of berry fruit crops that have emerged above the soil surface,
(c) optionally providing a second fungicidal composition comprising an alternate fungicide different form said first fungicide, and a fungicidally acceptable carrier such as in a suitable volume of water in a spray tank to form a spray composition) and applying the second composition at a time T₀ plus or minus (+/−) 5 to 20 days to a soil surface in the field, to foliage and/or to flowers of berry fruit crops that have emerged above the soil surface; and
(d) harvesting said berry fruit crop from about 0 to about 60 days after T₀; preferably from about 5 to about 45 days after T₀

In addition to the application of a fungicidal composition comprising the two-component mixture I+II, this invention also relates to a method of producing berry fruits having an enhanced quality, an extended shelf life and/or a reduced level of fungal contamination, which comprises treating a berry fruit crop, for example a berry fruit crop, that is infested or liable to be infested by fungi such as botrytis, anthracnose, and powdery mildew with a) the cyprodinil (I) and with b) the fludioxonil (II) in any desired sequence or simultaneously (also referred to herein as a I+II mixture) as provided above including an optional treatment comprising a second fungicidal composition comprising an alternate fungicide such as an alternate botrytis fungicide.

Advantageous mixing ratios of the cyprodinil (I) and the fludioxonil (II) fungicides are I:II=from 10:1 to 1:30, preferably I:II=from 7:1 to 1:20. In many cases, mixtures in which the mixing ratio of the active substances I:II is from 7:1 to 1:10, e.g. from 7:1 to 1:1 are advantageous. Other advantageous mixing ratios are 6:1, 7:2, 2:3 and 1.5:1.

Suitable target berry fruit crops include strawberry, blackberry, raspberry (black, red and golden varieties), blueberry and cultivars, varieties and/or hybrids of these.

In one embodiment, the present method of extending the shelf life of berry fruit crops is accomplished by a pre-harvest regimen of treatments with the I+II mixture over the growing season. Preferably, the I+II mixture is applied at least once at an early bloom or early flowering stage (such as 10% flowering). In another embodiment, the method of the invention contemplates a treatment regimen that is accomplished by (A) at least one application of the I+II mixture and (B) at least one application of a protectant such as an alternate botrytis fungicide product. Suitable alternate botrytis fungicides (also referred to herein as an alternate fungicide) include captan, thiram, iprodione (Rovora®), fenhexamid (Elevate®) and benomyl (Benlate®). Other suitable fungicides (C) include the stobilurin analogues such as trifloxystrobin, azoxystrobin, kresoxim-methyl, picoxystrobin and pyraclostrobin. Suitable rates for the alternate fungicides and other suitable fungicides are the existing rates given on the current product labels for such products. For example, Quadris® brand azoxystrobin can be applied at a rate from 112 g to 224 g a.i./hectare.

Advantageous rates of application of the active ingredient I+II mixture in the practice of the present method are normally from about 400 to about about 1000 g, preferably from about 480 g to about 615 g a.i./ha per treatment.

In a further embodiment, the application rate is from about 480 to about 500 g a.i./ha per treatment.

In another embodiment of the same invention, a berry crop is treated with a I+II mixture and treatments are repeated on a 5-20 day interval, preferably a 7-10 day interval until harvest.

In an alternate embodiment of the same invention, the regimen includes at least two treatments with a I+II mixture, preferably at least three treatments, and more preferably at least 4 treatments with a I+II mixture that are optionally interrupted (preceeded or followed) by one or more treatments with an alternate fungicide as defined above. The alternate treatments are spaced in time from the I+II mixture application by 5-20 days, preferably by 7-10 days.

In another embodiment of the same invention, a berry crop is treated at a pre-flowering to early flowering stage with a I+II mixture (or an alternate product) and treatments are repeated on a 5-20 day interval, preferably a 7-10 day interval until harvest wherein treatments are alternated between a I+II mixture and an alternate product.

In another embodiment of the same invention, a berry crop is treated at a pre-flowering to early flowering stage with a I+II mixture (or an alternate product) and treatments are repeated on a 5-20 day interval, preferably a 7-10 day interval until harvest wherein the treatments with I+II mixture are blocked (at least two sequential treatment after an interval as defined) with the I+II mixture “block” treatments interrupted (preceeded or followed) by one or more treatments with an alternate product as defined above.

In a specific embodiment, a berry crop is treated with a program comprising: (1) treatment with (B) an alternate fungicide at an early season stage, (2) a two application “block” treatment with (A) a I+II mixture starting from an early flowering to flowering stage; (3) a three application “block” treatment with (B) an alternate fungicide; (4) a two application “block” treatment with (A) a I+II mixture; and (5) an optional treatment with (B) an alternate fungicide. The treatments in the program are spaced by a 5-20 day interval, preferably a 7-10 day interval.

In another embodiment of the same invention, a berry crop is treated using a full season program (4-7 months depending on the growing season at a particular location) of the I+II mixture and optional alternate fungicide beginning at a pre-flowering stage which further comprises including within the program treatments of (C) other suitable fungicides such as strobilutins including azoxystrobin at labeled rates (112 g to 224 g a.i./hectare); (D) miticides such as avermectin (Agrimek®) at labeled rates (16 oz. per acre of a 0.15 lb per gallon solution), and R-metalaxyl (Ridomil Gold®) at labeled rates.

The harvested berry fruit treated in accordance with the method of the invention includes strawberry, blackberry, raspberry (black, red and golden varieties), blueberry and cultivars, varieties and/or hybrids of these having an increased shelf-life of from about 5 to about 14 days (also referred to herein as enhanced shelf-life berry fruit). Such berry fruit also exhibits enhanced quality including yield, organoleptic properties such as flavor, taste and texture and saftety due to use of reduced risk fungicide products and rates.

After harvest, the enhanced shelf-life berry fruit produced in accordance with the present method is then packaged in conventional packaging typically used for perishable food. Suitable packaging includes, for example, conventional clear plastic clamshell packages (from 4 oz. to about 1 lb, for example), crates containing a plurality of such clamshell packages, pint baskets, full- and half-crates of pint baskets and pallets containing the foregoing crates and or packages.

In accordance with the method of the present invention, the I+II mixtures are normally used in the form of formulations. Cyprodinil (I) and fludioxonil (II) can be applied to the area or berry plant to be treated simultaneously or in succession, if desired together with further carriers, surfactants or other application-promoting adjuvants customarily employed in formulation technology.

Suitable carriers and adjuvants can be solid or liquid and are the substances customarily employed in formulation technology, for example natural or regenerated mineral substances, solvents, dispersants, wetting agents, tackifiers, thickeners, binders or fertilisers.

The compounds of this combination are used in unmodified form or, preferably, together with the adjuvants conventionally employed in formulation technology. To this end they are conveniently formulated in known manner e.g. to emulsifiable concentrates, coatable pastes, directly sprayable or dilutable solutions, dilute emulsions, wettable powders, soluble powders, dusts, granulates, and also by encapsulation in e.g. polymer substances. As with the nature of the compositions, the methods of application, such as spraying, atomising, dusting, scattering, coating or pouring, are chosen in accordance with the intended objectives and the prevailing circumstances.

The formulations are prepared in known manner, typically by intimately mixing, grinding and/or extruding the active ingredients with extenders, e.g. solvents, solid carriers and, where appropriate, surface-active compounds (surfactants).

The agrochemical compositions usually comprise 0.1 to 99%, preferably 0.1 to 95%, of active ingredients of formulae I and II, 99.9 to 1%, preferably 99.9 to 5%, of a solid or liquid adjuvant, and 0 to 25%, preferably 0.1 to 25%, of a surfactant.

Whereas commercial products or wet or dry dressings will preferably be formulated as concentrates, the end user will normally use dilute formulations for developing plants.

The solid carriers typically used for dusts and dispersible powders are calcite, talcum, kaolin, montmorillonite or attapulgite, highly dispersed silicic acid or absorbent polymers. Suitable granulated adsorptive granular carriers are pumice, broken brick, sepiolite or bentonite, and suitable non-sorptive carriers are typically calcite or dolomite.

Depending on the nature of the active ingredients to be formulated, suitable surface-active compounds are nonionic, cationic and/or anionic surfactants having good emulsifying, dispersing and wetting properties. The term “surfactants” will also be understood as comprising mixtures of surfactants.

The surfactants customarily employed in formulation technology may be found in the following literature: “Mc Cutcheon's Detergents and Emulsifiers Annual” MC Publishing Corp., Glen Rock, N.J., 1988; and M. and J. Ash, “Encyclopedia of Surfactants”, Vol. I-III, Chemical Publishing Co., New York, 1980-1981.

The invention is illustrated by the following Examples wherein “active ingredient” signifies a mixture consisting of cyprodinil (I) and fludioxonil (II) in a specific mixing ratio. Amounts denoted are % by weight.

Extruder granulate

| | |
|---|---|
| active ingredient (I:II = 1.5:1) | 63.9%* |
| sodium lignosulfonate | 10% |
| Naphthalene sulfonic acid, dibutyl-, sodium salt | 3% |
| Dimethylpolysiloxane | 1% |
| Sodium Sulfate | 5% |
| Urea-formaldehyde copolymer | 6% |
| Diatomaceous earth | 10.1% |
| Maleic anhydride diisobutylene copolymer, sodium salt | 1% |

(*62.5% as 100% pure actives)

The active ingredient is mixed with the adjuvants, the mixture is ground and moistened with water. This mixture is extruded and then dried in a stream of air.

### BIOLOGICAL EXAMPLES

All examples are conducted under field conditions using accepted grower practices. The mixtures of I and II are applied to field grown plants, not as a post harvest berry treatment.

The mean percent control values that are presented in the examples 1-6 below are corrected means; in other words, the percent reduction of pest populations is calculated relative to the pest population level in untreated control plots. The use of corrected means is standard practice in field evaluations of pesticides. Corrected means are calculated as follows:

$$\frac{\begin{matrix}Mean Untreated Value - \\ Mean Treatment Value \times 100\end{matrix}}{Mean Untreated Value} = Corrected Mean Percent$$

In the following examples, Fungicide A=a mixture of cyprodinil (I) and fludioxonil (II) (mixing ratio 1.5:1) applied as a 62.5% by weight water dispersible granule (WG) formulation.

### Example 1

Performance of Fungicide a Against Botrytis Gray Mold of Strawberry. Fungicide A is applied in the field; berries are then harvested and placed into cool storage for shelf-life evaluations (no additional sprays were made after harvest). Fungicide A provides better control of this disease than the current standard programs of Captan®and Rovral®, under severe disease conditions. The shelf-life of strawberry is extended to 7 days after harvest (41 days after the last application of fungicide A).

TABLE 1

| | | % Pest Incidence | | % Pest Incidence | |
|---|---|---|---|---|---|
| | | Fruit Rating | | Fruit Rating | |
| | | 7 Day Storage | | 7 Day Storage | |
| | Rate | Rating | | Rating | |
| Product | (g. a.i./HA) | Inoculated | % Control | Non-inoculated | % Control |
| Untreated | | 71 | | 20 | |
| Check | | | | | |
| Captan* | 3364 | 51 | 28% | 6 | 70% |
| Rovral* | 841 | 56 | 21% | 8 | 60% |
| A** | 615*** | 4 | 94% | 0 | 100% |
| | | | Control | | Control |

*Note:
Eight applications on a 10-day interval. Variety ‘Chandler’
**Note:
Four applications on a 10-day interval followed by a protectant
***615 g ai/HA is equivalent to 14 oz. of a fungicide A 62.5 WG/Acre.

### Example 2

Comparative Performance of Fungicide a Against Botrytis Gray Mold of Strawberry.

Fungicide A is applied in the field; berries are harvested and then placed into cool storage for shelf-life evaluations, with no additional sprays after harvest. Fungicide A provides better control of this disease than the current standard program consisting of Captan® and Benlate® alternated with Rovral. The shelf-life of strawberry is extended to 10+ days after harvest (also 18 days after the last Fungicide A application).

TABLE 2

| | | % Pest Incidence | |
|---|---|---|---|
| | Rate | Fruit Rating | % |
| Product | (g. a.i./HA) | 15+ Day Storage Rating | Control |
| Untreated Check | | 12.25 | |
| Captan + Benlate | 1120 + 560 | 6.25 | 49% |
| alt w/Rovral* | alt w/ | | |
| | 840 | | |
| A** | 615*** | 1.75 | 86% |
| | | | Control |

*Note:
Six applications on a 7-day interval. Variety ‘Chandler’
**Note:
Three applications of Fungicide A on a 7-day interval alternated with a protectant
***615 g ai/HA is equivalent to 14 oz. of Fungicide A 62.5 WG/Acre.

### Example 3

Efficacy Summary of Fungicide a Against Botrytis Gray Mold of Strawberry.

Fungicide A is applied to field grown strawberries and shelf-life evaluations are made. In the final evaluation, Fungicide A provides better control of this disease than the current standards, Thiram®/Benlate/Rovral, under severe disease conditions.

Healthy berries are harvested from each treatment, placed into cold storage and evaluated after 6 days for Botrytis control (see table below). Healthy berries are harvested again from each treatment, placed in cold storage and evaluated after 6 days for Botrytis control (see table below). The shelf-life of strawberry is extended to 6 days after harvest (also 16 days after the last Fungicide A application).

TABLE 3

| | | | % Disease | | % Disease | |
|---|---|---|---|---|---|---|
| | | | Control | Disease | Control | Yield |
| | Rate | Disease | 6 Day Storage | Incidence + | 6 Day Storage | (Grams/ |
| Product | (g. a.i./HA) | Incidence | Rating | 6 days | Rating | Plot) |
| Untreated | | 43 | | 61 | | 5,347 |
| Check | | | | | | |
| Thiram + | Standard | 23 | 47% Control | 59 | 3% Control | 6,567 |
| Benlate alt w/ | Labeled | | | | | |
| Rovral | Rate | | | | | |
| A | 620* | 7 | 84% Control | 17 | 72% Control | 6,723 |

Variety ‘Camarosa’
*620 g ai/HA is equivalent to 14 oz. of Fungicide A 62.5 WG/Acre.

### Example 4

Comparative Performance of Fungicide a Against Botrytis Gray Mold of Strawberry

Fungicide A is applied in the field; berries are harvested and placed into storage for shelf-life evaluations, with no additional sprays after harvest. Fungicide A provides better control against this disease than the current standard program, Captan® and Benlate alternated with Rovral®, under severe disease conditions. The shelf-life of strawberry can be extended to 5-9 days after harvest (41 days after the last Fungicide A application).

TABLE 4

| | | % Pest Incidence | | % Pest Incidence | |
|---|---|---|---|---|---|
| | Rate | Fruit Rating | % | Fruit Rating | % |
| Product | (g. a.i./HA) | 5 Day Storage Rating | Control | 9 Day Storage Rating | Control |
| Untreated | | 17.5 | | 66.25 | |
| Check | | | | | |
| Captan + | 1120 + 560 | 3.75 | 79% | 23.75 | 64% |
| Benlate alt | alt w/ | | | | |
| w/Rovral* | 840 | | | | |
| A** | 984 | 1.25 | 93% | 8.75 | 87% |
| | | | Control | | Control |

*Note:
Eight applications on a 7-day interval. Variety ‘Chandler’;
**Note:
Four applications on a 7-day interval followed by a protectant.

### Example 5

Efficacy Summary of Fungicide a Against Botrytis Gray Mold of Blackberry

Fungicide A is applied to field-grown blackberries and shelf-life evaluations made. In the final evaluation, Fungicide A provides better control of this disease than the current standards, Captan and Rovral, under severe disease conditions.

Healthy berries are harvested from each treatment and placed into storage and evaluated for Botrytis and Rhizopus control (see table below). The shelf-life of blackberry is extended to 14 days after harvest

TABLE 5

| | | % Rhizopus | | % Botrytis | | % Botrytis | |
|---|---|---|---|---|---|---|---|
| | | Infected | | Infected | | Disease | |
| | | Berries | | Berries | | Control | |
| | Rate | (from | | (from | | (14 Day Storage | |
| Product | (g. a.i./HA) | Harvest)* | | Harvest) | | Rating) | |
| Untreated | | 38.5 | d\hat{ } | 27.6 | d | | |
| Check | | | | | | | |
| Captan alt | Standard | 1.6 | a | 17.2 | c | 38% | Control |
| w/Rovral | Labeled Rate | | | | | | |
| A** | 614 | 0.5 | a | 0 | a | 100% | Control |

*At the harvest, only two fungicide applications had been made.
**614 g ai/HA is equivalent to 14 oz. of Fungicide A 62.5 WG/Acre.
\hat{ }Numbers followed by the same letters are not statistically different (Fisher's protected LSD, P 0.05)

### Example 6

Efficacy Summary of Fungicide a Against Botrytis Gray Mold of Red Raspberry

Fungicide A is applied to field grown red raspberry and shelf-life evaluations made. In the final evaluation, Fungicide A provides better control of this disease than the current standards, Captan and Rovral, under severe disease conditions.

Healthy berries are harvested from each treatment and placed into storage and evaluated for Botrytis control (see table below). The shelf-life of red raspberry is extended to 6 days after harvest.

TABLE 6

| | | | |
|---|---|---|---|
| | | % Botrytis | % Botrytis |
| | | Infect Berries | Disease Control |
| | Rate | (6 Day Storage | (6 Day Storage |
| Product | (g. a.i./HA) | Rating) | Rating) |

| | | | | | |
|---|---|---|---|---|---|
| Untreated | | 95.3 | a** | | |
| Check | | | | | |
| Captan | 2244 | 88.2 | ab | 7% | Control |
| Rovral | 1122 | 89.9 | ab | 6% | Control |
| A* | 614 | 34.7 | d | 64% | Control |

*614 g ai/HA is equivalent to 14 oz. of Fungicide A 62.5 WG/Acre.
**Numbers followed by the same letters are not statistically different (Duncan's Multiple Range Test, P 0.05)

### Example 7

Summary of Fungicide a Efficacy Against Botrytis Gray Mold of Strawberry and Extension of Berry Shelf-life

Table 7 shows the comparative performance of Fungicide A against Botrytis gray mold of strawberry. Fungicide A is applied in the field; berries are harvested and then placed into storage for shelf-life evaluations, with no additional sprays after harvest. Fungicide A provides better control of this disease than the current standard program consisting of Captan® and Thiram. The shelf-life of strawberry is extended to 7+ days after harvest according to this study.

TABLE 7

| | | % Pest Incidence | | |
|---|---|---|---|---|
| | | Nov. 29, 1999 | | |
| | | Fruit Rating | | |
| | Rate | 7+ Day Storage | | % |
| Product | (g. a.i./HA) | Rating | | Control |
| Captan alt w/ | Standard Rate | 67.8 | a | |
| Thiram (Standard | | | | |
| Grower Program) | | | | |
| Fungicide A* | 615* | 25.17 | b | 63% |
| | | | | Control over |
| | | | | Standard |
| | | | | Program |

*615 g ai/HA is equivalent to 14 oz. of Fungicide A 62.5 WG/Acre.

### Example 8

Summary of Switch Fungicide Efficacy Against Botrytis Gray Mold of Red Raspberry

Table 8 provides the efficacy summary of Fungide A alternation program against Botrytis gray mold of red raspberry. Fungicide A is applied to field grown red raspberry and shelf-life evaluations made. In the final evaluation, Switch alternation program provides better control of this disease than the current standards, Elevate and Rovral program, under moderate disease conditions.

Healthy berries are harvested from each treatment and placed into storage and evaluated for Botrytis control (see table below). The shelf-life of red raspberry is extended to 7 days following this program.

TABLE 8

| | | % Botrytis | | % Botrytis |
|---|---|---|---|---|
| | | Infected Berries | | Disease Control |
| | Rate | (7 Day Storage | | (7 Day Storage |
| Product | (g. a.i./HA) | Rating) | | Rating) |
| Untreated | | 27.8 | b** | |
| Check | | | | |
| Rovral | Standard Rate | 5.0 | d | 82% Control |
| alternated w/ | | | | |
| Elevate | | | | |
| Fungicide A | 439 | 0.2 | e | 99% Control |
| program alt | | | | |
| w/Elevate | | | | |

*439 g ai/HA is equivalent to 10 oz. of Fungicide A 62.5 WG/Acre.
**Numbers followed by the same letters are not statistically different (Waller Duncan's Test, P 0.05)

In summary, it is seen that this invention provides a new method for enhancing the shelf life of berry fruit. Variations may be made in proportions, procedures and materials without departing from the scope of the invention as defined by the following claims.

What is claimed is:

1. A method of producing berry fruits having an extended shelf life and enhanced organoleptic properties, comprising:
(a) providing a first fungicidal composition comprising a mixture of cyprodinil (I) and fludioxonil (II), and a fungicidally acceptable carrier;
(b) applying said fungicidal composition at a time T₀ to a soil surface in the field, to foliage and/or to flowers of berry fruit crops that have emerged above the soil surface,
(c) optionally providing a second fungicidal composition comprising an alternate fungicide different form said first fungicide, and a fungicidally acceptable carrier and applying the second composition at a time T₀ plus or minus 5 to 20 days to a soil surface in the field, to foliage and/or to flowers of berry fruit crops that have emerged above the soil surface; and
(d) harvesting said berry fruit crop from about 0 to about 60 days after T₀.

2. A method of claim 1 wherein said crop is harvested within a period of time from about 5 to about 45 days after T₀.

3. A method of claim 1 wherein said berry fruit crop is selected from the group consisting of strawberries, raspberries and blackberries.

4. A method of claim 1 wherein the ratio by weight of the mixture of I:II in said fungicidal composition is from 10:1 to 1:30.

5. A method of claim 4 wherein the ratio weight of the mixture of I:II is 1.5:1.

6. A method of claim 4 wherein the rate of application of the active ingredient mixture is from 400 to 1000 g a.i./ha.

7. A method of claim 6 wherein the rate of application of the active ingredient mixture is from 480 to 615 g a.i./ha

8. A berry fruit produced according to the method of claim 1.

9. The berry fruit of claim 8 selected from the group consisting of strawberries, raspberries and blackberries.

10. A package for perishable food containing a berry fruit produced according to the method of claim 1.

11. A package of claim 10 wherein the berry fruit is selected from the group consisting of strawberries, raspberries and blackberries.
